(19) United States
(12) Patent Application Publication
(10) Pub. No.: US 2026/0349786 A1
(43) Pub. Date: Nov. 5, 2026

(54) METHOD AND SYSTEM WITH A MULTI-CORE MICROCONTROLLER WITH CHAINED TASK AND OFFLOAD LOGIC

(71) Applicant: Schaeffler Technologies AG & Co. KG, Herzogenaurach (DE)

(72) Inventors: Stéphane ELOY, Toulouse (FR); Franck DELPECH, Toulouse (FR)

(21) Appl. No.: 19/123,687

(22) PCT Filed: Nov. 21, 2023
(86) PCT No.: PCT/EP2023/082457

§ 371 Date: Apr. 23, 2025

(30) Foreign Application Priority Data
Nov. 28, 2022 (FR) 2212415

(51) Int. Cl. G06F 9/48

(52) U.S. Cl. CPC G06F 9/4881

(57) ABSTRACT

A method implemented in a multi-core microcontroller with a first core and a second core, the method comprising:
defining a recurrent chained task that can be executed in sections on the first and second cores, involving a nominal implementation associated with a reference distribution of the sections over the various cores, the second core requiring a second latency time (DL2) for dealing with a second section (TK2) of the chained task;
estimating a current value of the second latency time;
if the current value of the second latency time is greater than a first threshold value (DS2a), then activating a mode for offloading the second core in which a head section of the second section is executed on the first core and is deactivated on the second core;
if the value of the second latency time is less than a second threshold value, then returning to the nominal implementation.

### TECHNICAL FIELD

The present invention relates to the methods implemented in a multi-core microcontroller in a control unit in a motor vehicle. In particular, the focus is a control unit in a motor vehicle, notably a control unit for an internal combustion engine, or a torque distribution unit in a hybrid drive system.

### Prior Art

Multi-core microcontrollers are increasingly used in the electronic control units in motor vehicles. This architecture provides significant flexibility in terms of the management and the execution of the many tasks that must be performed by the electronic control unit.

In some software configurations, the tasks to be periodically executed include a category that is of particular interest within the scope of the present invention and that involves tasks called “chained” tasks. A chained task is executed in sections on a plurality of cores. The relevant sections are executed sequentially, by each respective core that is involved. In practice, for a chained task of interest, a first section of the task is performed by a first core of the microcontroller, a second section of the task is performed by a second core of the microcontroller, and so on. The first section of the task yields a result that is used by the second section of the task, and so on.

In a control unit as mentioned in the introduction, the recurrence period of certain chained tasks is related to the running speed of the engine and, in addition, some additional tasks are triggered on running speed thresholds. Under these conditions, the chained task of interest, in its nominal implementation, may have an execution time that becomes greater than the recurrence period of the task. When this phenomenon occurs and is amplified, this can result in erroneous task results, or even a reset of the microcontroller.

In addition, when the execution of a chained task is terminated on a given core, its execution on the next core starts when allowed by the operating system of this core, according to its priority and tasks with potentially higher priority that are pending execution. Therefore, if the chained task is not subsequently executed on the next core because other higher priority tasks are executed, this chained task will be executed with a delay.

The inventors have sought to improve the situation.

### DISCLOSURE OF THE INVENTION

To this end, according to the present disclosure, a method is proposed that is implemented in a multi-core microcontroller in a control unit in a motor vehicle, the microcontroller comprising a first core, a second core and possibly at least one third core, the method comprising the following steps of:
a—defining a chained task that can be executed in sections on at least the first and second cores, involving an implementation, called nominal implementation, of the chained task associated with a reference distribution of the sections over the various cores, and the chained task being executed recurrently, the first core requiring a first latency time (DL1) for dealing with a first section of the chained task, the second core requiring a second latency time (DL2) for dealing with a second section of the chained task;
b2—estimating a current value of the second latency time (DL2) based on one or more previous executions of the chained task;
c2—if the estimated current value of the second latency time (DL2) is greater than a first predetermined threshold value (DS2a), then activating a mode for offloading the second core in which a head section of the second section is executed on the first core and is deactivated on the second core;
d2—if the estimated current value of the second latency time (DL2) is less than a second predetermined threshold value (DS2b), then returning to the nominal implementation, with the head section of the second section being re-executed on the second core and deactivated on the first core.

The first section of the chained task refers to the section of the chained task that is executed by the first core, the second section of the chained task is the section of the chained task that is executed by the second core, etc. The content of the first section, respectively of the second section, can change from one execution of the chained task to the next.

The first predetermined threshold value is denoted DS2a. The second predetermined threshold value is denoted DS2b. The second latency time is denoted DL2. The first latency time is denoted DL1.

When DL2>DS2a, this means that the second core is intensively used and is utilized by other tasks, which leads to a longer time for dealing with sections than normal.

It should noted that the thresholds DS2a and DS2b can be the same or different, as will be seen hereafter.

In the offloading mode, the head section of the second section of the chained task is no longer executed on the second core but is executed on the first core; therefore, the second core is relieved of some of its work. The offloading is reversible and the offloading mode is momentary.

In cases of low load or of moderate load for the cores, the latency times are short and the total execution time of the chained task is less than the recurrence period of the chained task.

In a control unit as mentioned in the introduction, under high recurrence conditions for certain tasks related to the running speed of the engine, the invention allows the phenomenon of a time-out mentioned in the introductory section to be avoided or at least reduced.

By virtue of the proposed offloading mechanism, the risks of such a time-out and of a possible reset of the microcontroller are reduced, and the reliability of the control software associated with said chained task is thus improved.

In various embodiments of the invention, one or more of the following features also may be employed, alone or in combination.

According to one aspect of the invention, provision can be made for:
when the third core is present, and under the conditions of the mode for offloading the second core, an end section of the second section to be executed on the third core and deactivated on the second core; and
when returning to the nominal implementation, the end section to be re-executed on the second core and deactivated on the third core.

This allows significant offloading to be organized for the second core, with a section offloaded on the first core and another section offloaded on the third core. The offloaded load is thus distributed over two other cores, which represents an optimization.

According to one aspect of the invention, the method can further comprise the following steps of:
b1—estimating a current value of the first latency time (DL1) based on one or more previous executions of the chained task;
c1—if the estimated current value of the first latency time (DL1) is greater than a third predetermined threshold value (DS1a), then activating a mode for offloading the first core in which a head section of the first section is executed on the second core and is deactivated on the first core;
d1—if the estimated current value of the first latency time (DL1) is less than a fourth predetermined threshold value (DS1b), then returning to the nominal implementation, with the head section of the first section being re-executed on the first core and deactivated on the second core.

It is thus possible to offload the first core A1 if it is overloaded. It should be noted that the first latency time is defined between the initiation of an iteration of the chained task by a sequencer (with the initiation time being denoted LTK(i)) and the start of execution (denoted tb1) on the first core A1.

According to one aspect of the invention, provision can be made for, with the third core being present, the third core to require a third latency time (DL3) for dealing with a third section of the chained task, and the method further comprises the following steps of:
b3-estimating a current value of the third latency time (DL3) based on one or more previous executions of the chained task;
c3—if the estimated current value of the third latency time (DL3) is greater than a fifth predetermined threshold value (DS3a), then activating a mode for offloading the third core in which a head section of the third section is executed on the second core and is deactivated on the third core;
d3—if the estimated current value of the third latency time (DL3) is less than a sixth predetermined threshold value (DS3b), then returning to the nominal implementation, with the head section of the third section being re-executed on the third core and deactivated on the second core.

It is thus possible to offload the third core A3 if it is overloaded.

According to one aspect of the invention, with respect to the predetermined threshold for triggering the mode for offloading the second core, provision can be made for the first predetermined threshold value (DS2a) to be strictly greater than the second predetermined threshold value (DS2b).

In other words, the return to normal, or nominal, operation is triggered on a latency time threshold that is lower than the threshold that initiated the offloading mode. This provides a hysteresis function that allows unnecessary frequent switching to be avoided between the offloading mode and the nominal mode. It should be noted that the values of the relevant thresholds are a few microseconds, for example, between 700 and 2,500 microseconds for a chained task with a recurrence period of 10 ms.

It should be noted that, in an alternative embodiment, the predetermined thresholds DS2a and DS2b can be equal and that by using low-pass filtering this also works correctly. The successively measured values for the second latency time DL2 notably can be introduced into a low-pass digital filter or into a windowed average filter, thereby avoiding triggering offloading on a single value above the threshold, and in the opposite direction when returning to nominal operation, on a single value below the threshold.

According to one aspect of the invention, with respect to the predetermined threshold for triggering the mode for offloading the first core, provision can be made for the third predetermined threshold value (DS1a) to be strictly greater than the fourth predetermined threshold value (DS1b).

In other words, the return to nominal operation is triggered on a latency time threshold that is lower than the threshold that initiated the offloading mode. As before, this provides a hysteresis function that allows unnecessary frequent switching to be avoided.

According to one aspect of the invention, the current value of the second latency time DL2 can be computed as an average over the M last executions of the chained task. Similarly, the current value of the first latency time DL1 can be computed as an average over the M last executions of the chained task. Similarly, if the third core is present, the third latency time DL3 also can be computed as an average over the M last executions of the chained task.

According to a particular aspect, the chained task can be executed in a periodic asynchronous manner, with the period being dependent on the running speed of the engine of the motor vehicle. In particular, when the recurrence frequency is proportional to the engine running speed, the risk of a time-out mentioned in the introductory section increases, and the offloading as described above is increasingly relevant.

According to a particular aspect, the chained task is initiated by a sequencer of the operating system.

The chained task is a consolidation of sequentially executed functions. Said functions are high-level functions, and not simple mathematical functions. Rather, these are entities, or procedures, that consolidate (i.e., encapsulate) code defining logical processing, computations, requests for library functions, etc. As a variant, the chained task directly includes the code defining said logical processing, computations, requests for library functions, etc.

According to one aspect of the invention, provision can be made for:
the first section of the chained task to comprise, in a nominal execution, a base section followed by an end section;
the second section of the chained task to comprise, in a nominal execution, a base section preceded by a head section and followed by an end section;
with the base sections being derived from a predefined division.

According to one aspect of the invention, the mode for offloading the first core is exclusive of the mode for offloading the second core. In view of the presented mechanism, the core with load issues is relayed by the neighboring (previous and/or following) cores, which are not offloaded but instead are loaded slightly more.

According to one aspect of the invention, it is possible to choose to preferably offload the core experiencing the most difficulty, in other words, the one with the longest latency time.

A further aim of the present invention is a multi-core microcontroller configured to implement the method described above, with the relevant microcontroller being preferably used in a control unit in a motor vehicle.

A further aim of the present invention is an electronic control unit comprising the microcontroller as described above.

### DESCRIPTION OF THE FIGURES

Further aspects, aims and advantages of the invention will become apparent upon reading the following description of an embodiment of the invention, which is provided by way of a non-limiting example. The invention also will be understood better with reference to the accompanying drawings, in which:

FIG. 1 illustrates a highly simplified block diagram of an example of an engine control system;

FIG. 2 shows an illustrative example of the timing diagram concerning the execution of a chained task in a nominal configuration;

FIG. 3 is similar to FIG. 2 and illustrates a case of offloading the second core;

FIG. 4 is similar to FIG. 2 and illustrates a case of offloading the first core;

FIG. 5 is similar to FIG. 2 and illustrates a case of offloading the third core;

FIG. 6 schematically shows an operational flow chart of the offloading of the second core.

### DETAILED DESCRIPTION OF AT LEAST ONE EMBODIMENT

The same references denote identical or similar elements throughout the various figures. For the sake of the clarity of the disclosure, some elements are not necessarily shown to scale, in particular the times and durations shown in the timing diagrams are not necessarily shown to scale.

The invention is illustrated within the context of an internal combustion engine control system. The invention can be generally used for smart controllers on board a motor vehicle that manage highly complex computations, such as, for example, but not exclusively, hybrid engine torque distributors.

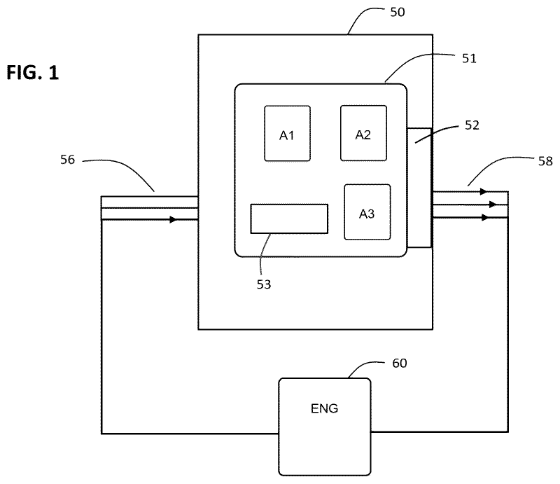

With reference to FIG. 1, said engine 60 is equipped with actuators and sensors connected to a control unit 50.

The information fed back by the sensors passes through conductors that are connected as inputs 56 of the electronic control unit 50.

The control unit comprises a microcontroller 51. Said microcontroller comprises a first computing core A1, a second computing core A2 and a third computing core A3 in the illustrated example. The third core is optional and it also should noted that there could be a fourth core or a greater number of cores.

The microcontroller 51 interfaces with an output interface 52, with power switches, for example. The control unit provides output commands 58 intended for controlling the actuators arranged on the engine or generally in the drive function.

Furthermore, the microcontroller 51 comprises a memory zone 53, which can be accessed by the various computing cores.

The microcontroller 51 is equipped with an operating system. The operating system comprises a task sequencer intended for scheduling and sequencing the various tasks undertaken by the microcontroller.

Some tasks are executed on a specific core. However, the tasks of interest herein are those that are executed on several cores, and in particular the tasks that are not executed on several cores at the same time, but in series. These types of tasks are referred to as “chained tasks”.

For a chained task, a division is defined in advance, i.e., a distribution of the various sections of the task to be executed, on different computing cores, with, if applicable, optional sub-sections, i.e., sub-sections that may or may not be executed according to the operational conditions at the time, as will be seen hereafter, for example, with or without offloading.

In practice, the relevant sections are executed sequentially by each respective core that is involved. For a chained task of interest, a first section of the task is performed by the first core of the microcontroller and a second section of the task is performed by the second core of the microcontroller. In the illustrated example, there is also a third core executing a third section of the chained task. In variants, not shown, more than three cores are involved, each executing a respective section of a task.

A first section of the chained task refers to the section of the chained task that is executed by the first core, the second section of the chained task refers to the section of the chained task that is executed by the second core, etc. As will be seen hereafter, the content of the first section, respectively of the second section, can change from one execution of the chained task to the next.

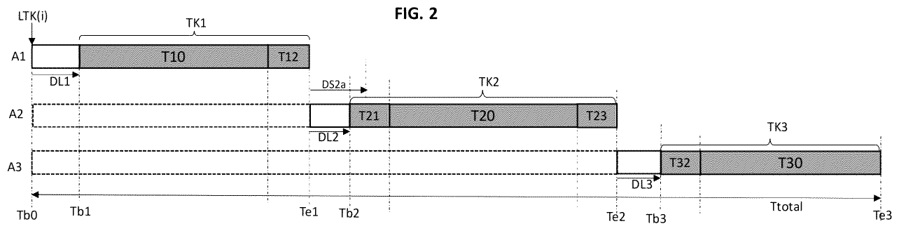

The first section TK1 comprises, in a nominal execution (denoted TK1-n) illustrated in FIG. 2, a base section T10 followed by an end section T12.

The second section TK2 comprises, in a nominal execution (denoted TK2-n), a base section T20 preceded by a head section T21 and followed by an end section T23.

The third section TK3 comprises, in a nominal execution (denoted TK3-n), a base section T30 preceded by a head section T32.

The respective base sections T10, T20, T30 are derived from a predefined division. They are always executed on their respective core.

However, the head sections and the end sections may be subject to a reallocation decision for offloading a core from among the two or three cores.

A preliminary step of the method according to the invention involves defining a chained task TK that can be executed in sections on at least the first and second cores (A1, A2), with an implementation, called nominal implementation, of the chained task associated with a reference distribution of the sections over the various cores.

As illustrated in FIGS. 2 to 5, the first core A1 requires a first latency time DL1 for dealing with the first section TK1 of the chained task, the second core A2 requires a second latency time DL2 for dealing with the second section TK2 of the chained task. Furthermore, when the third core is present, as in the illustrated example, the third core A3 requires a third latency time DL3 for dealing with a third section TK3 of the chained task.

The chained task TK is executed recurrently. In a simple example, the recurrence frequency is fixed. In another fairly common example, the recurrence frequency is proportional to the running speed of the vehicle engine. The faster the engine runs, the higher the recurrence frequency of the chained task, and therefore the smaller the repetition period of said task. For example, for an engine running at 6,000 rpm, the recurrence frequency of one engine revolution is 100 Hz, and therefore a task performed for each revolution has a duration of 10 ms. If several tasks, which may or may not be chained, are triggered on the engine tooth signal or on the camshaft signal, the load of the various cores of the microcontroller can be very high. Under these conditions, dividing the tasks into parts and sections can yield a result that is difficult to forecast because the latency times can become very high, with the cores being occupied by tasks with potentially higher priority. It is under these conditions that the time-out mentioned in the introductory section can occur, all the more so since hardware interruptions take over with high priority over the executions of ongoing tasks and can mean that the forecasting of the loads of the various cores is random.

The first, second, and third latency times DL1, DL2, DL3 manifest themselves for each execution of the chained task, possibly involving a change for each one in the upward direction or in the downward direction.

The proposed method includes the step of:
b2—estimating the second latency time DL2 based on one or more previous executions of the chained task.

Optionally, the proposed method can include the step of:
b1—estimating the first latency time DL1 based on one or more previous executions of the chained task.

Optionally, the proposed method can include the step of:
b3—estimating the third latency time DL3 based on one or more previous executions of the chained task.

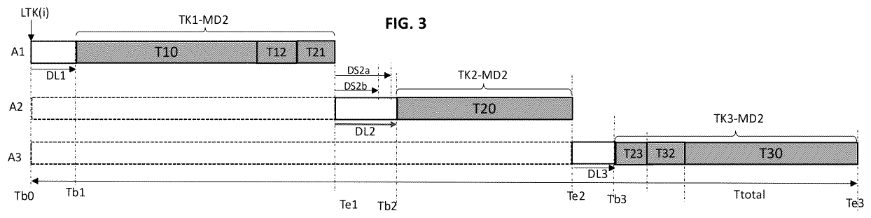

In the configuration illustrated in FIG. 3, the second latency time DL2 has exceeded a first predefined threshold denoted DS2a, and a mode for offloading the second core is then implemented.

In this offloading mode, denoted MD2, the first task section, executed on the first core A1, comprises a base section T10 followed by the end section T12, and followed by the head section T21, which was normally executed on the second core but is now executed on the first core. The first task section, in this offloading mode MD2, is denoted TK1-MD2.

In the illustrated example, the second core merely involves implementing the base section T20 of the second task section. The second task section, in this offloading mode MD2, is denoted TK2-MD2.

Indeed, according to this optional configuration with a third core, the end section T23 is no longer executed on the second core A2, but instead it is executed on the third core A3.

The third task section, executed on the third core A3, thus comprises, in the mode MD2, the end section T23 of the second task as defined in the nominal mode, the head section T32, and the base section T30. The third task section, in this offloading mode MD2, is denoted TK3-MD2.

Of course, if the second latency time DL2 becomes reasonable and nominal, (in practice, if it meets the criterion DL2<DS2b, where DS2b is a second predefined threshold), then the offloading mode is abandoned and the nominal operating mode is resumed, as illustrated in FIG. 2.

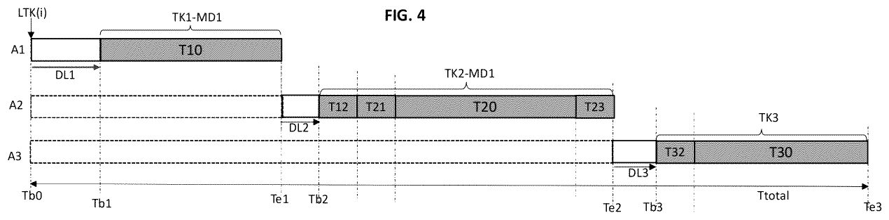

In the configuration illustrated in FIG. 4, the first latency time DL1 has exceeded a third predefined threshold, denoted DS1a, and a mode for offloading the first core, denoted MD1, is then implemented.

The end section T12 of the first section as defined in the nominal mode is then executed on the second core A2 and is deactivated on the first core A1.

The operation of the second core A2 is modified by the addition at the beginning of the end section T12. The second task section, in this offloading mode MD1, is denoted TK2-MD1.

In the mode MD1, the first core A1 only implements the base section T10. The first task section, in this offloading mode MD1, is denoted TK1-MD1.

The operation of the third core A3 remains nominal in this case.

Of course, if the latency time DL1 becomes reasonable and nominal, (in practice, if it meets the criterion DL1<DS1b, where DS1b is a fourth predetermined threshold), then the offloading mode MD1 is abandoned and the nominal operating mode is resumed, as illustrated in FIG. 2.

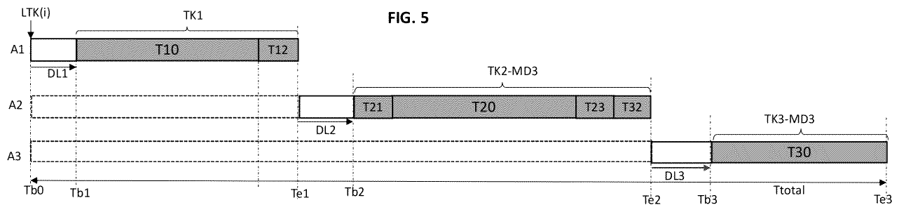

In the configuration illustrated in FIG. 5, the third latency time DL3 has exceeded a fifth predefined threshold, denoted DS3a, and a mode for offloading the third core, denoted MD3, is implemented.

The head section T32 of the third section as defined in the nominal mode is then executed on the second core A2 and is deactivated on the third core A3. The third task section, in this offloading mode MD3, is denoted TK3-MD3.

The operation of the second core A2 is modified by the addition of the third task at the end of the head section T32. The second task section, in this offloading mode MD3, is denoted TK2-MD3.

The operation of the first core A1 remains nominal in this case.

According to the same previous logic, if the third latency time DL3 becomes reasonable and nominal, (in practice, if it meets the criterion DL3<DS3b, where DS3b is a sixth predetermined threshold), then the offloading mode MD3 is abandoned and the nominal operating mode is resumed, as illustrated in FIG. 2.

Each task section comprises a set of functions.

The first task section starts to be executed at the time Tb1. The first task section is terminated at the time Te1. The second task section starts to be executed at the time Tb2. The second task section is terminated at the time Te2. The third task section starts to be executed at the time Tb3. The third task section is terminated at the time Te3.

The latency times are defined by:
DL2=Tb2−Te1
DL1=Tb1−LTK(i), with the index i representing the recurrence of a request for the chained task TK,
D13=Tb3−Te2.

The second latency time DL2 can be computed as an average over the M last executions of the chained task TK. The same applies for the first latency time DL1 and the third latency time DL3. For example, M=3 can be selected.

The current value of the third latency time DL3 is advantageously an average value computed over the M last executions of the chained task TK.

It is understood from the mechanism as disclosed above that the mode for offloading a core is often exclusive of the mode for offloading its neighbors (previous and following) in the chain. However, it should be noted that the cores A1 and A3 can be simultaneously offloaded on the core A2. The possibilities of simultaneous offloading increase if the microcontroller comprises four or more cores.

It also should noted that in the event that two latency times increase at the same time, the offloading of the core with the greatest latency time will be preferred. Thus, the core in most difficulty will be offloaded.

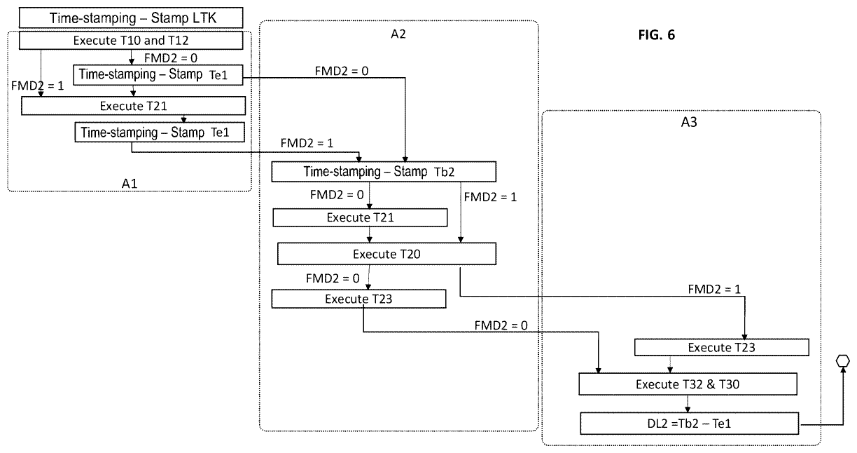

FIG. 6 uses a logic diagram to show the logic for triggering the mode for offloading the second core and the use of a beacon, or flag, denoted FMD2.

The block on the left represents the operation in the first core A1. At the beginning, the sequencer or the first core time stamps the system time and stores it in the variable LTK(i). Furthermore, the first core executes the base section T10 under any circumstances. In the illustrated example of offloading the second core, the first core also executes the end section of the first task, namely, the section T12. The next step then depends on the value of the flag FMD2, which represents the mode for offloading the second core when it is set to the value of 1.

In the nominal case where this flag FMD2 is 0, the first core has completed its mission concerning the first task section TK1. Otherwise, when FMD2 is 1, then the first core A1 also executes the head section T21 of the second task.

At the end of the execution undertaken by the first core A1, the first core time stamps the system time and stores it in the variable Te1. At this point of the process, the results of the first task section are made available to the second core A2.

At the beginning of the process performed by the second core A2, illustrated by the central block in FIG. 6, the second core time stamps the system time and stores it in the variable Tb2.

In the nominal case where the flag FMD2 is 0, the second core executes the head section T21 and then the base section T20 and then the end section T23.

Otherwise, when FMD2 is 1, then the second core only executes the base section T20.

It should be noted in this case that offloading in the third core is an option that is only implemented when this third core is present in the configuration of the microcontroller.

Upon completing the execution that is undertaken by the second core A2, the results of the second task section are made available to the third core A3.

In the nominal case where the flag FMD2 is 0, the third core executes the head section T32 and then the base section T30.

Otherwise, when FMD2 is 1, then the third core executes the end section T23, then the head section T32, and then the base section T30.

Finally, the current value of the latency time DL2 is computed by computing DL2=Tb2−Te1, with this computation being used for the next execution of the task TK.

The logic diagram shown can be supplemented with the management of the flag FMD1 for offloading the first core and optionally of the flag FMD3 for offloading the third core. The applied logics are then the same or similar, mutatis mutandis, as those disclosed in detail for the flag FMD2.

Advantageously, the sequencer is only involved in initiating the task at the times LTK(i). The rest of the process, in particular the activation of an offloading mode or the return to nominal operation, is performed at a logical level of the computing cores by virtue of the management of the flags FMD2, FMD1, and optionally FMD3.

Typical values for the latency times, notably the first, second and third latency times DL1, DL2 and DL3, range between 100 μs and 1 ms, more specifically between 300 μs and 700 μs. Typical values of threshold values DSa (the first threshold value DS2a, respectively the third threshold value DS1a, respectively the fifth threshold value DS3a) are approximately 2 ms, for example, between 1.8 ms and 2.2 ms. Typical values of threshold values DSb (the second threshold value DS2b, respectively the fourth threshold value DS1b, respectively the sixth threshold value DS3b) are approximately 1.2 ms, for example, between 1.0 ms and 1.4 ms.

### Miscellaneous

In the illustrated example, it should be noted that the computing power of one of the cores A1, A2, A3 is less than a computing power of an equivalent powered single-core microcontroller, but the sum of the computing powers of the cores A1, A2, A3 is greater than the computing power of an equivalent powered single-core microcontroller.

It should be noted that the proposed method can be used not only on internal combustion engine vehicles but also on hybrid vehicles and on 100 % electric vehicles within the context of the torque and speed control of electric motors.

1. A method implemented in a multi-core microcontroller (51) in a control unit (50) in a motor vehicle, the microcontroller comprising a first core (A1), a second core (A2) and possibly at least one third core (A3), the method comprising the following steps of:
a—defining a chained task (TK) that can be executed in sections on at least the first and second cores (A1, A2), involving an implementation, called nominal implementation, of the chained task associated with a reference distribution of the sections over the various cores, and the chained task (TK) being executed recurrently, the first core (A1) requiring a first latency time, DL1, for dealing with a first section (TK1) of the chained task, the second core (A2) requiring a second latency time, DL2, for dealing with a second section (TK2) of the chained task;
b2—estimating a current value of the second latency time DL2 based on one or more previous executions of the chained task;
c2—if the estimated current value of the second latency time DL2 is greater than a first predetermined threshold value, DS2a, then activating a mode for offloading the second core in which a head section (T21) of the second section is executed on the first core (A1) and is deactivated on the second core (A2);
d2—if the estimated current value of the second latency time DL2 is less than a second predetermined threshold value, DS2b, then returning to the nominal implementation, with the head section (T21) of the second section being re-executed on the second core (A2) and deactivated on the first core (A1).

2. The method as claimed in claim 1, with the third core being present, wherein provision is made for:
in the mode for offloading the second core (A2), an end section (T23) of the second section to be executed on the third core (A3) and deactivated on the second core (A2); and
when returning to the nominal implementation, the end section (T23) to be re-executed on the second core (A2) and deactivated on the third core (A3).

3. The method as claimed in claim 1, further comprising the following steps of:
b1—estimating a current value of the first latency time DL1 based on one or more previous executions of the chained task;
c1—if the estimated current value of the first latency time DL1 is greater than a third predetermined threshold value, DS1a, then activating a mode for offloading the first core in which a head section (T12) of the first section is executed on the second core (A2) and is deactivated on the first core (A1);
d1—if the estimated current value of the first latency time DL1 is less than a fourth predetermined threshold value, DS1b, then returning to the nominal implementation, with the head section (T12) of the first section being re-executed on the first core (A1) and deactivated on the second core (A2).

4. The method as claimed in claim 1, wherein, with the third core being present and the third core (A3) requiring a third latency time, DL3, for dealing with a third section (TK3) of the chained task, the method further comprises the following steps of:
b3—estimating a current value of the third latency time DL3 based on one or more previous executions of the chained task;
c3—if the estimated current value of the third latency time DL3 is greater than a fifth predetermined threshold value, DS3a, then activating a mode for offloading the third core in which a head section (T32) of the third section is executed on the second core (A2) and is deactivated on the third core (A3);
d3—if the estimated current value of the third latency time DL3 is less than a sixth predetermined threshold value, DS3b, then returning to the nominal implementation, with the head section (T32) of the third section being re-executed on the third core (A3) and deactivated on the second core (A2).

5. The method as claimed in claim 3, wherein:
the first predetermined threshold value DS2a is strictly greater than the second predetermined threshold value DS2b; and/or
the third predetermined threshold value DS1a is strictly greater than the fourth predetermined threshold value DS1b.

6. The method as claimed in claim 1, wherein the current value of the second latency time DL2 is an average value computed on the M last executions of the chained task (TK).

7. The method as claimed in claim 1, wherein the current value of the first latency time DL1 is an average value computed on the M last executions of the chained task (TK).

8. The method as claimed in claim 1, wherein the chained task (TK) is executed in a periodic asynchronous manner, with the period being dependent on the running speed of the engine (60) of the motor vehicle.

9. The method as claimed in claim 1, wherein:
the first section (TK1) of the chained task comprises, in a nominal execution (TK1-n), a base section (T10) followed by an end section (T12);
the second section (TK2) of the chained task comprises, in a nominal execution (TK2-n), a base section (T20) preceded by a head section (T21) and followed by an end section (T23); with the base sections (T10, T20) being derived from a predefined division.

10. The method as claimed in claim 3, wherein the mode for offloading the first core is exclusive of the mode for offloading the second core.

11. A multi-core microcontroller (51) in a control unit (50) in a motor vehicle, the microcontroller being configured to implement the method as claimed in claim 1.

12. A control unit (50) comprising a multi-core microcontroller (51) as claimed in claim 11.
